(19) United States
(12) Patent Application Publication
(10) Pub. No.: US 2022/0193792 A1
(43) Pub. Date: Jun. 23, 2022

(54) CABINET HARDWARE TEMPLATE AND METHOD OF USE

(71) Applicant: Top Knobs USA, Inc., Branchburg, NJ (US)

(72) Inventor: Ashley Owens Harvey, Benton, LA (US)

(73) Assignee: Top Knobs USA, Inc., Branchburg, NJ (US)

(21) Appl. No.: 17/247,658

(22) Filed: Dec. 18, 2020

(51) Int. Cl. B23B 49/02; B25H 7/02; G01B 3/04

(52) U.S. Cl. CPC B23B 49/02; G01B 3/04; B25H 7/02

(57) ABSTRACT

A template and method for installation of handles on cabinet doors and drawer faces is provided. The template including multiple sets of concentric ordered hole pairs which correspond to standard handle lengths. The template also provides convenient vertical and horizontal etchings and English and metric scales along the edges for precise repeatable measurement.

### FIELD OF THE INVENTION

The present invention relates generally to cabinetry wood working tools, and specifically to templates for installing handles on cabinet doors and drawer faces.

### BACKGROUND OF THE INVENTION

Installation of handles on cabinet doors and drawer faces typically requires that a pair of matching holes be drilled in precise, repeatable, locations. If the holes are not positioned precisely, then the handle will appear off center or misaligned and the aesthetic appeal of the cabinet system will be reduced. Furthermore, precise positioning must be repeated across multiple doors and drawer faces to produce a uniform appearance to an entire cabinet system.

To accomplish repeatable precision hole location, the prior art has attempted various solutions.

In FIG. 1, prior art template 1 is shown to have a template base 5, incorporating offset flanges 2 and 3 several sets of alignment holes 4, to assist in marking holes for handle installation.

In use, one of alignment flanges 2 or 3 is positioned against the top of a drawer or cabinet door. Template base 5 is then positioned against the face of a drawer or cabinet door. Holes 4 are then used to mark a set of hole positions for the cabinet handle.

However, prior art template 1 is not a satisfactory solution because it can only be used with a limited range of sizes of cabinet faces due to the fixed distance between the alignment edges and the holes. It is also not satisfactory because there is no repeatable method to position the template horizontally.

Another example of a prior art solution is shown in U.S. Pat. No. 6,804,891 to Hurtgam, et al. Hurtgam discloses a template with a scale and an insert with a single set of holes which may be positioned horizontally or vertically. However, precise alignment of the insert is difficult due to the inability to position the cross-member at a repeatable angle. Further, precise measurement of large doors or drawers is not possible because of the limited length of the tool.

U.S. Pat. No. D511,961 to Jordan discloses a template with alignment holes. However, the template must be used in conjunction with other tools or templates because there is no means to precisely measure the locations for the holes. Similarly, the template does not provide a method of alignment, which results in difficulty with hole placement.

Hence, the prior art lacks a solution which is capable of providing precise and repeatable horizontal and vertical hole locations in a cabinet door or drawer face for a variety of cabinet handles.

### SUMMARY OF THE INVENTION

The invention disclosed provides a flat template with a novel set of alignment lines associated with holes in ordered pairs which allow for installation of a handles without the use of multiple tools. The invention can be used for both cabinets and doors regardless of the size or orientation. Further, the invention includes both metric and English scales for use with metric or English handles. The ordered pairs of holes correspond to standard metric and English lengths of handles.

In use, the template and method disclosed allow for precise repeatable placement of handles on the face of cabinet doors and drawer faces of any size without limiting the location of the handle.

### BRIEF DESCRIPTION OF THE DRAWINGS

In the detailed description of the preferred embodiments presented below, reference is made to the accompanying drawings.

FIG. 1 is an isometric view of a prior art template.

FIG. 2A is an isometric view of a preferred embodiment of the template.

FIG. 2B is a plan view of a preferred embodiment of the template.

FIG. 2C is a plan view of an alternate embodiment of the template.

FIG. 3 is a flowchart for use of a preferred embodiment.

FIGS. 4A and 4B are isometric views of the template used for a drawer.

FIG. 5 is a flowchart for use of a preferred embodiment.

FIGS. 6A and 6B are isometric views of the template used for a door.

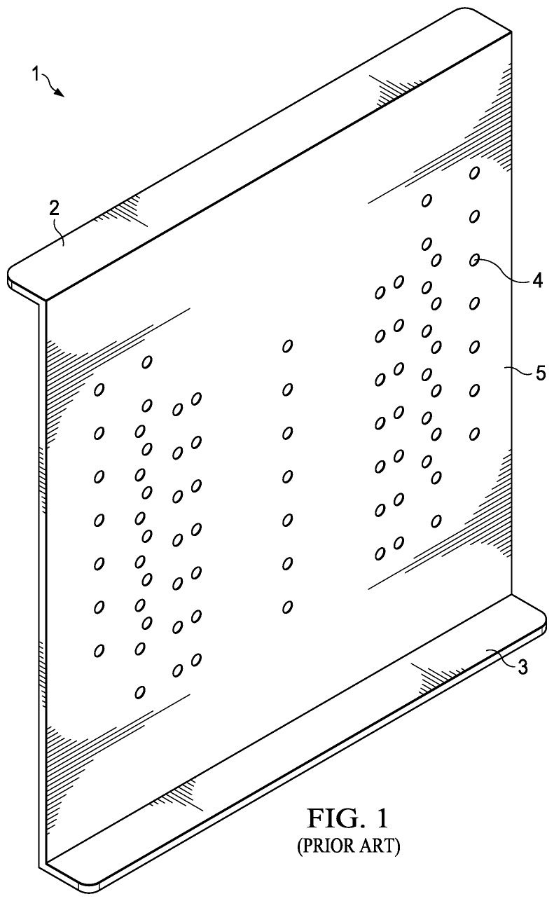

### DETAILED DESCRIPTION OF THE INVENTION

In the description that follows, like parts are marked throughout the specification and figures with the same numerals, respectively. The figures are not necessarily drawn to scale and may be shown in exaggerated or generalized form in the interest of clarity and conciseness.

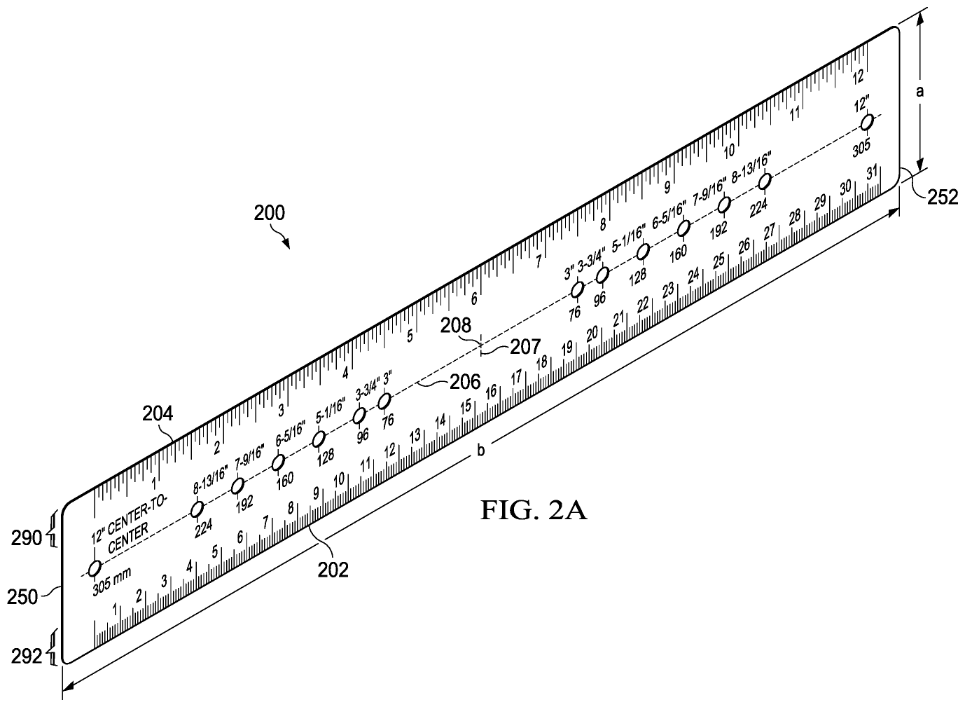

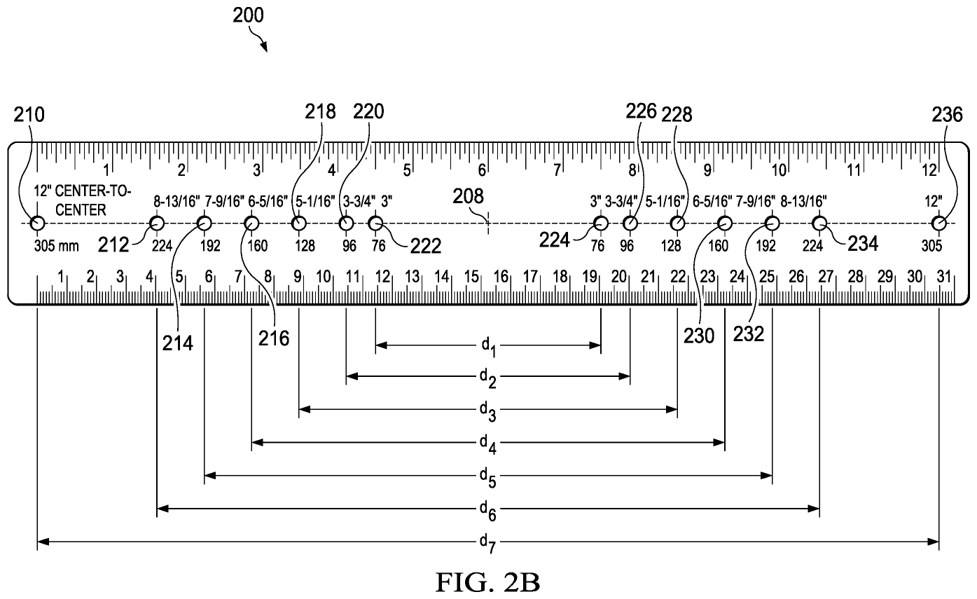

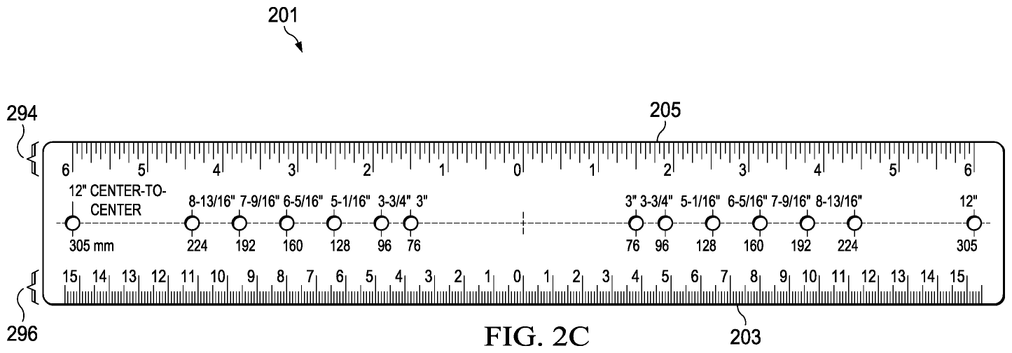

Referring to FIGS. 2A and 2B, template 200 is shown. Template 200 is generally rectangular in shape having height a of approximately 2″±0.25″, and width b of approximately 13″±0.25″. The template is preferably comprised of a sheet of flexible thermoplastic, or acrylic, such as a polycarbonate, having a thickness of between about 10 mils and about 20 mils±25%. In a preferred embodiment, template 200 is either transparent or semi-transparent. Using a transparent material allows for more accurate alignment with drawn lines and cabinet edges.

In a preferred embodiment, template 200 includes English scale 290 along edge 204 and metric scale 292 along edge 202. In this embodiment, the English scale is 12″ and the metric scale is 31 cm in length. Other lengths may be used.

Template 200 includes horizontal center line 206 and vertical center line 207. Horizontal center line 206 is preferably a dashed opaque line etched at the horizontal center of the template parallel to edges 202 and 204. Vertical center line 207 is a preferably a dashed opaque line etched at the vertical center of the template, parallel to edges 250 and 252. Vertical center line 207 is generally perpendicular to horizontal center line 206. Crosshairs 208 are formed at the intersection of vertical center line 207 and horizontal center line 206.

Template 200 is further comprised of alignment holes 210, 212, 214, 216, 218, 220, 222, 224, 226, 228, 230, 232, 234, and 236. The alignment holes are configured in seven (7) ordered pairs, as will be further described. Each alignment hole is approximately 3/16″ in diameter and is centered vertically on horizontal center line 206.

Each ordered pair is positioned at a different distance from the cross hairs to accommodate handle of different sizes. In this embodiment, the template includes seven (7) concentric ordered pairs of holes. However, it should be appreciated that different numbers of ordered pairs of holes may be used. The ordered pairs are positioned concentrically along horizontal center line 206 such that crosshairs 208 are located at the central point of each of the ordered pairs.

In a preferred embodiment, ordered pair d₁ is comprised of alignment holes 222 and 224. Ordered pair d₁ has a center-to-center length of 3″, or 76 mm. Ordered pair d₂ is comprised of alignment holes 220 and 226. Ordered pair d₂ has a center-to-center length of 3¾″, or 96 mm. Ordered pair d₃ is comprised of alignment holes 218 and 228. Ordered pair d₃ has a center-to-center length of 5 1/16″, or 128 mm. Ordered pair d₄ is comprised of alignment holes 216 and 230. Ordered pair d₄ has a center-to-center length of 6 5/16″, or 160 mm. Ordered pair d₅ is comprised of alignment holes 214 and 232. Ordered pair d₅ has a center-to-center length of 7 9/16″, or 192 mm. Ordered pair d₆ is comprised of alignment holes 212 and 234. Ordered pair d₆ has a center-to-center length of 8 13/16″, or 224 mm. Ordered pair d₇ is comprised of alignment holes 210 and 236. Ordered pair d₇ has a center-to-center length of 12″, or 305 mm.

Referring then to FIG. 2C, an alternate embodiment of the template is shown. Template 201 includes zero centering English scale 294 along edge 205 and zero centering metric scale 296 along edge 203. In this embodiment, the English scale is 0-6″ and the metric scale is 0-15.5 cm in length. Other lengths and measurement scales may be used.

The use of zero centering scales is advantageous because it allows the user to find a center point quickly by positioning the template against the door face such that each side of the zero centering scale reads the same measurement on both sides of the template at the same time, as will be further described.

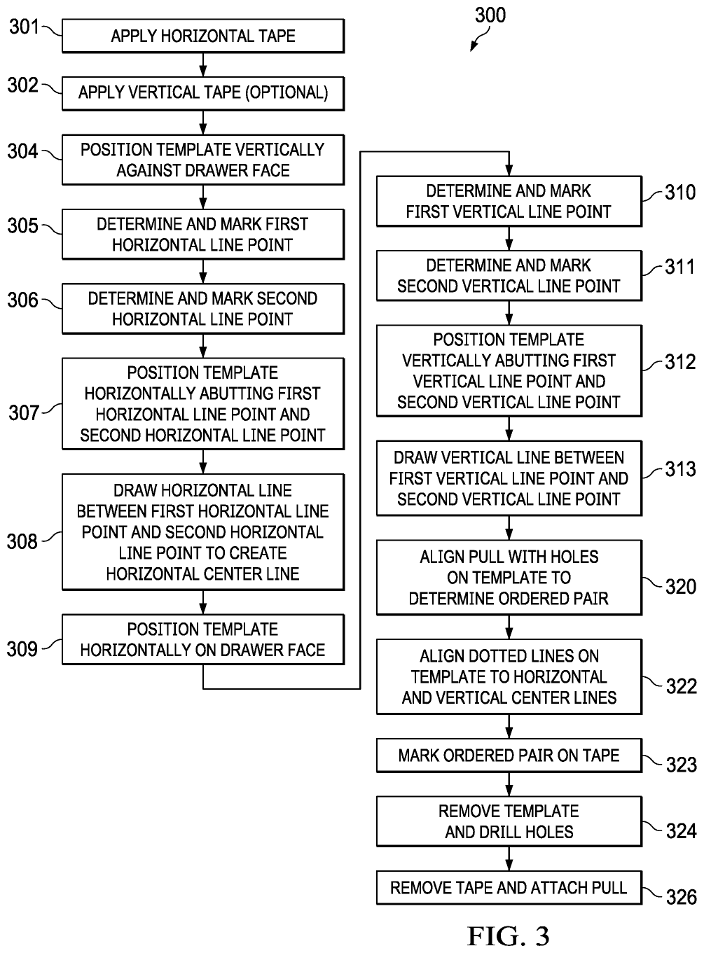

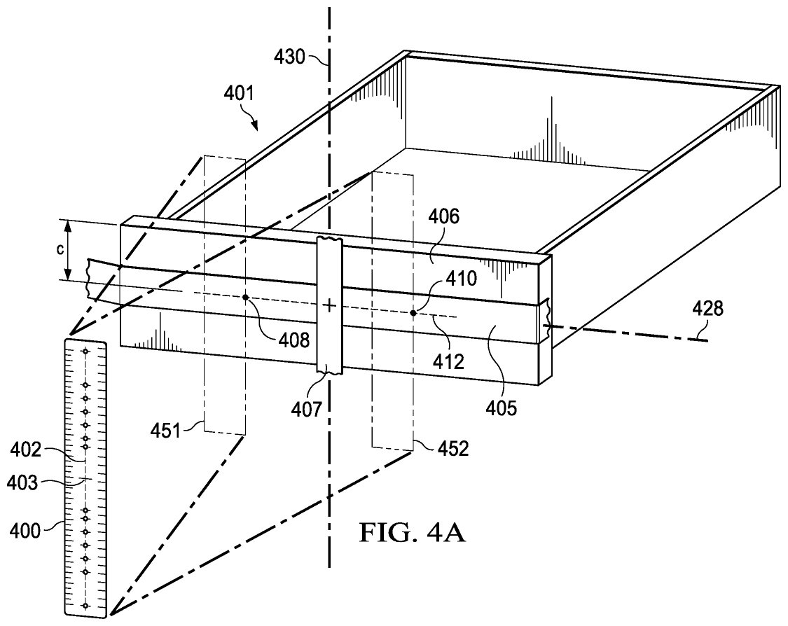

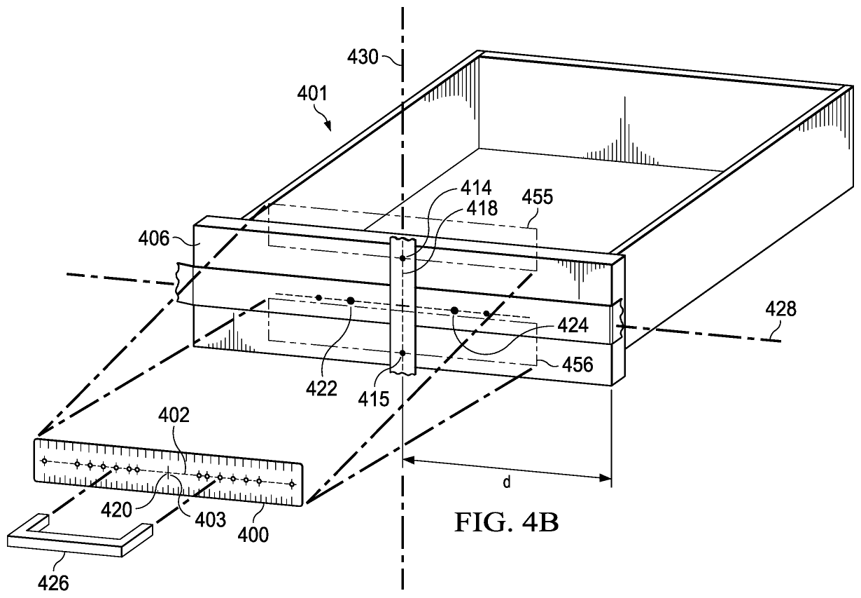

Referring then to FIGS. 3, 4A, and 4B, method 300 for use of a preferred embodiment to install a horizontal handle on a drawer face will be described. Method 300 describes a handle is installed horizontally at the center of a drawer face. However, it should be appreciated that in alternate embodiments, the method may be used to install handles oriented off-center or vertically.

At step 301, painters tape 405 is applied generally horizontally along horizontal center axis 428 of the drawer face. True horizontal alignment is not required. The tape allows measurements to be marked directly on the door without damaging the surface of the drawer face.

At step 302, optionally painters tape 407 is applied generally vertically along vertical center axis 430 of the drawer face. True vertical alignment is not required.

As shown best in FIGS. 3 and 4A, at step 304, template 400 is positioned vertically against the drawer face at a first position 451.

At step 305, the height of the drawer face is measured by using either the English or the metric scale on template 400. The height is divided by two to determine the horizontal center of the drawer face. A first horizontal line point 408 is marked on the painters tape at the horizontal center.

At step 306, template 400 is moved to a second position 452 on the drawer face and the metric scale or English scale is used to mark a second horizontal line point 410 at the horizontal center of the drawer face.

Alternatively, at steps 305 and 306, the zero centering measurement scales of template 201 may be used to find horizontal line points 408 and 410 of the drawer face. In this embodiment, template 201 is positioned on the drawer face and aligned such that the same measurement value is visible through the template for both the top and bottom edges of the drawer face. By aligning the template in this manner, the zeros of each of zero centering English scale 294 and zero centering metric scale 296, will be precisely at the horizontal center of the drawer face.

At step 307, template 400 is positioned horizontally on drawer face, such that edge 204 or edge 202 abuts first horizontal line point 408 and second horizontal line point 410.

At step 308, a horizontal line is drawn on painters tape 405 through first horizontal line point 408 and second horizontal line point 410 to create horizontal center line 412 along horizontal center axis 428.

At step 309, template 400 is positioned horizontally against the drawer face at a third position 455. At step 310, the width of the drawer face is measured using either the English or metric scale on template 400. The width is divided by two to determine the vertical center of the drawer face. A first vertical line point 414 is marked on the tape at vertical center. At step 311, template 400 is positioned at a fourth position 456 and a second vertical line point 415 is marked on the tape at the vertical center.

Alternatively, at steps 309 and 310, the zero centering measurement scales of template 201 may be used to find vertical line points 414 and 415 of the drawer face. In this embodiment, template 201 is positioned on such that the same measurement value is visible through the template for both the left and right edges of the drawer face. By aligning the template in this manner, the zeros of each of zero centering English scale 294 and zero centering metric scale 296, will be precisely at the vertical center of the drawer face.

At step 312, template 400 is positioned vertically against the drawer face with either edge 204 or edge 202 abutting first vertical line point 414 and second vertical line point 415.

At step 313, a vertical line is drawn along the edge of the template between first vertical line point 414 and second vertical line point 415 to create vertical center line 418.

The intersection of vertical center line 418 and horizontal center line 412 creates center point 420. This is the center point of the drawer face.

At step 320, example handle 426 is aligned with template 400 to determine an ordered pair of holes that corresponds to the width of the handle. At step 322, template 400 is positioned horizontally on the drawer face and crosshairs 403 are aligned with center point 420. Horizontal center line 402 is aligned with horizontal center line 412, and vertical center line 207 is aligned with vertical center line 418.

At step 323, marks are made on the tape through each hole of the ordered pair, determined in step 320, to create hole markers 422 and 424. At step 324, the template is removed and holes are drilled at hole markers 422 and 424. The holes should be drilled from the front of the drawer face. At step 326, the tape is removed and the handle is attached to drawer face 406, by screws.

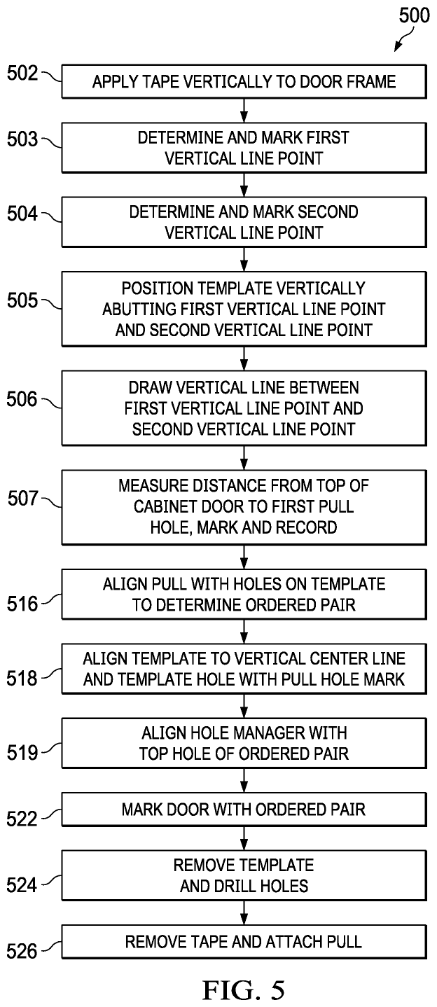

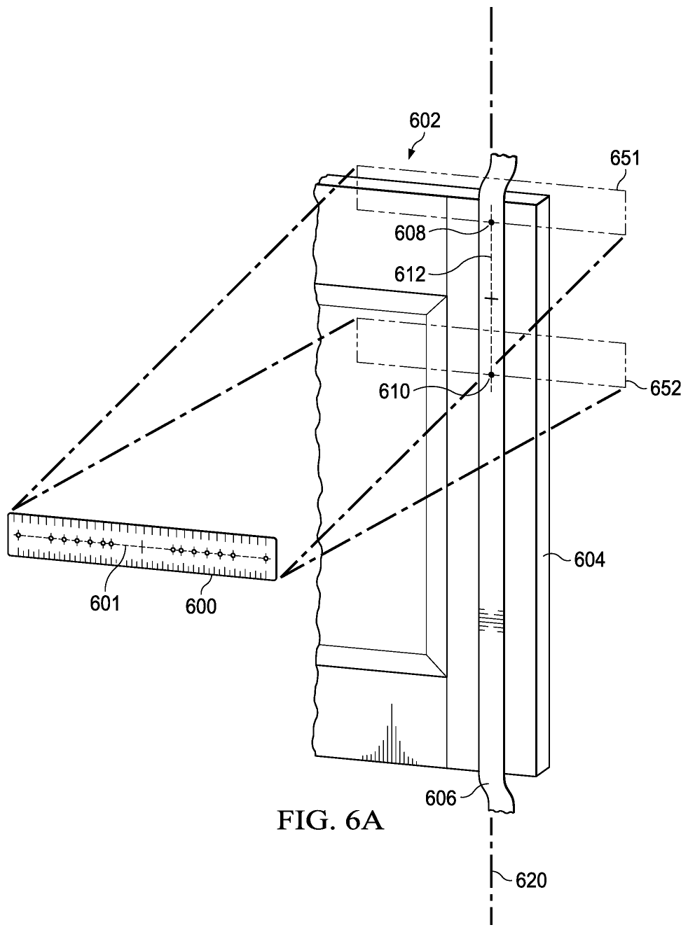

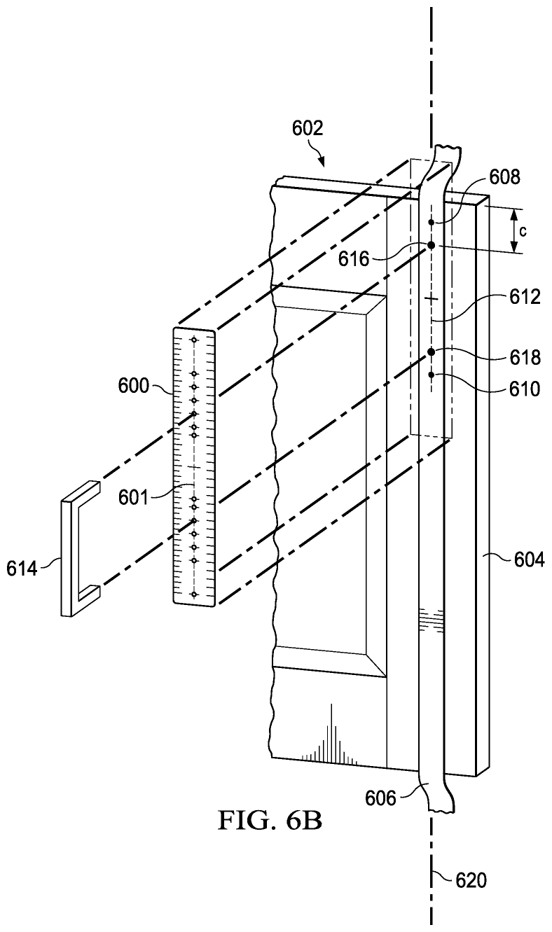

Referring then to FIGS. 5, 6A, and 6B, method 500 for using a template on a cabinet door will be described.

At step 502, painters tape 606 is applied generally vertically along vertical center axis 620 of door frame 604. True vertical alignment is not required. The tape allows measurements to be marked directly on the door without damaging the surface of cabinet door 602.

As shown best in FIGS. 5 and 6A, at step 503, the width of the door frame is measured by placing template 400 horizontally against the door frame at a first position 651 and using either the English or metric scale on the template 400 to determine the width of the door frame. The width of door frame is divided by two to determine the door frame vertical center. First vertical line point 608 is then marked at the vertical center.

In like manner, at step 504 template 400 is positioned at a second position 652 and a second vertical line point 610 is then marked on the tape at the vertical center.

Alternatively, at steps 502 and 504, the zero centering measurement scales of template 201 may be used to find vertical line points 608 and 610 of the door frame. In this embodiment, template 201 is positioned such that the same measurement value is visible through the template for both the left and right edges of the door frame, as previously described.

As best shown in FIGS. 5 and 6B, at step 505 template 400 is then positioned vertically abutting edge 202 or edge 204 against first vertical line point 608 and second vertical line point 610. At step 506, a vertical line is drawn on painters tape 606 between first vertical line point 608 and second vertical line point 610 to create vertical center line 612. Vertical center line 612 indicates the vertical center line of door frame 604.

At step 507, either the English or metric scale of the template is used to measure distance “c” from the top of cabinet door 602, and the position is marked at hole marker 616. Distance “c” is arbitrary and so must be recorded for use on other cabinet doors in the cabinet system. If the method is being applied to a second or following cabinet door in the cabinet system, then the dimension “c” is used from prior measurements to position the top hole of the ordered pair.

At step 516, example handle 614 is aligned with template 600 in order to locate an ordered pair of holes that corresponds to the dimensions of the handle. At step 518, the template is placed vertically on the door face such that horizontal center line 601 is aligned with vertical center line 612. At step 519, hole marker 616 is aligned with the top hole of the chosen ordered pair determined at step 516.

At step 522, hole marker 618 is marked at the bottom hole of the chosen ordered pair determined in step 516. At step 524, the template is removed and holes are drilled at hole markers 616 and 618, as previously described. At step 526, the tape is removed and the handle is attached to cabinet door 602, as previously described.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

1. A device for positioning a handle comprising:
a transparent, flexible, flat, substrate having a height and a width, the width greater than the height;
the substrate further comprising a first horizontal edge along the width and a second horizontal edge along the width;
a visible horizontal centerline, parallel to the first edge and the second edge, spanning at least a portion of the width of the substrate;
a visible vertical centerline crossing the visible horizontal centerline to form a set of cross hairs;
a plurality of concentric ordered hole pairs, positioned along the visible horizontal centerline, centered at the set of cross hairs; and,
a first measurement scale, positioned along the first horizontal edge.

2. The device of claim 1 further comprising:
a second measurement scale, different than the first measurement scale, positioned along the second horizontal edge.

3. The device of claim 2 wherein the first measurement scale is an English scale and the second measurement scale is a metric scale.

4. The device of claim 3 wherein the substrate is comprised of one of the group of an acrylic plastic and a polycarbonate plastic.

5. The device of claim 4 wherein the plurality of concentric ordered hole pairs further comprises:
a first ordered pair centered within a second ordered pair;
the second ordered pair centered within a third ordered pair;
the third ordered pair centered within a fourth ordered pair;
the fourth ordered pair centered within a fifth ordered pair;
the fifth ordered pair centered within a sixth ordered pair; and,
the sixth ordered pair centered within a seventh ordered pair.

6. The device of claim 5 wherein:
the first ordered pair is placed at a 3 inch center distance;
the second ordered pair is placed at a 3¾ inch center distance;
the third ordered pair is placed at a 5 1/16 inch center distance;
the fourth ordered pair is placed at a 6 5/16 inch center distance;
the fifth ordered pair is placed at a 7 9/16 inch center distance;
the sixth ordered pair is placed at a 8 13/16 inch center distance; and,
the seventh ordered pair is placed at a 12 inch center distance.

7. The device of claim 6 wherein the substrate has a thickness of between about 10 mils and about 25 mils.

8. The device of claim 7 wherein the plurality of concentric ordered hole pairs are marked with corresponding English and metric units.

9. A method of positioning a handle, having two handle holes, on a drawer face comprising:
providing a transparent, flexible, flat substrate having a height and a width, the width greater than the height;
providing the substrate further comprising a first horizontal edge and a second horizontal edge;
providing a visible horizontal centerline, parallel to the first edge and the second edge spanning the width of the substrate;
providing a visible vertical centerline crossing the visible horizontal centerline to form a set of cross hairs;
providing a plurality of concentric ordered hole pairs, positioned along the visible horizontal centerline, centered at the cross hairs;
providing a measurement scale, positioned along the first horizontal edge; and,
positioning the substrate vertically against the drawer face at a first position;
determining and marking a first horizontal line point on the drawer face using the measurement scale;
positioning the substrate vertically against the drawer face at a second position, different than the first position;
determining and marking a second horizontal line point on the drawer face using the measurement scale;
positioning the substrate horizontally on the drawer face, abutting the first horizontal line point and the second horizontal line point;
drawing a horizontal line on the drawer face between the first horizontal line point and the second horizontal line point;
positioning the substrate vertically against the drawer face at a third position, different than the first position and the second position;
determining and marking a first horizontal line point on the drawer face using the first measurement scale;
positioning the substrate vertically against the drawer face at a fourth position, different from the first position, the second position and the third position;
determining and marking a second horizontal line point on the drawer face using the first measurement scale;
positioning the substrate horizontally on the drawer face abutting the first horizontal line point and the second horizontal line point;
drawing a horizontal line on the drawer face between the first horizontal line point and the second horizontal line point;
aligning the pair of handle holes with one set of concentric ordered hole pairs of the plurality of concentric ordered hole pairs;
aligning the visible horizontal centerline with the horizontal line;
marking the drawer face through the one set of concentric ordered hole pairs to create a set of hole markings;
removing the substrate from the drawer face;
drilling a pair of through holes through the set of hole markings;
positioning the two handle holes adjacent the pair of through holes; and,
attaching the handle to the drawer face using a pair of screws through the pair of through holes and the two handle holes.

10. The method of claim 9 further comprising:
affixing a horizontal tape generally along a horizontal axis of the drawer face; and,
affixing a vertical tape generally along a vertical axis of the drawer face.

11. The method of claim 9 wherein the step of determining and marking a first horizontal line point further comprises:
measuring a height of the drawer face using the measurement scale; and,
dividing the height of the drawer face by a factor of two.

12. The method of claim 9 wherein:
the step of providing a measurement scale further comprises providing a zero centering measurement scale, positioned along one of the first horizontal edge and the second horizontal edge; and,
the step of determining and marking a first vertical line point further comprises aligning the substrate so that an identical measurement reading is indicated at two points on the zero centering measurement scale.

13. The method of claim 9 wherein the step of determining and marking a first vertical line point further comprises:
measuring a width of the drawer face; and,
dividing the width of the drawer face by a factor of two.

14. The method of claim 13 wherein the step of measuring further comprises:
using one of an English scale resident on the substrate and a metric scale resident on the substrate.

15. The method of claim 9 further comprising:
placing the cross hairs at an intersection of the horizontal line and the vertical line.

16. A method of positioning a first handle, having two handle holes, on a first cabinet door having a first door frame, further comprising:
providing a transparent flexible flat substrate having a height and a width, the width greater than the height;
providing the substrate further comprising a first horizontal edge and a second horizontal edge;
providing a visible horizontal centerline, parallel to the first edge and the second edge spanning the width of the substrate;
providing a visible vertical centerline crossing the visible horizontal centerline to form a set of cross hairs;
providing a plurality of concentric ordered hole pairs, positioned along the visible horizontal centerline, centered at the cross hairs;
providing a first measurement scale, positioned along the first horizontal edge; and,
providing a second measurement scale, different than the first measurement scale, positioned along the second horizontal edge;
positioning the substrate horizontally against the first door frame at a first position;
determining and marking a first vertical line point on the first door frame using one of the first measurement scale and the second measurement scale;
positioning the substrate vertically against the first door frame at a second position, different than the first position;
determining and marking a second vertical line point on the first door frame using one of the first measurement scale and the second measurement scale;
drawing a vertical line on the first door frame between the first vertical line point and the second vertical line point;
determining a first top hole location;
marking the first top hole location on the vertical line;
aligning the pair of handle holes with one set of concentric ordered hole pairs of the plurality of concentric hole pairs;
aligning the visible horizontal centerline with the vertical line and a top ordered pair hole of the one set of concentric ordered hole pairs with the top hole location;
marking a bottom hole location through a bottom ordered pair hole of the one set of concentric ordered hole pairs to create a set of hole markings on the first door frame through the one set of concentric ordered hole pairs to create a set of hole marking;
removing the substrate from the first door frame;
drilling a pair of through holes through the set of hole markings;
positioning the two handle holes adjacent the pair of through holes; and,
attaching the handle to the first door frame using a pair of screws through the pair of through holes and the two handle holes.

17. The method of claim 16 further comprising:
affixing a vertical tape generally along a vertical axis of the first door frame.

18. The method of claim 16 wherein the step of determining and marking a first vertical line point further comprises:
measuring a width of the first door frame; and,
dividing the width by a factor of two.

19. The method of claim 18 wherein the step of measuring further comprises:
using one of an English scale resident on the substrate and a metric scale resident on the substrate.

20. The method of claim 16 further comprising:
recording a top hole location distance;
providing a second cabinet door having a second door frame; and,
marking a second top hole location on the second door frame at the top hole location distance.

21. The method of claim 20 further comprising:
affixing a second handle to the second door frame based on the second top hole location.
